(19) United States
(12) Patent Application Publication
(10) Pub. No.: US 2026/0063658 A1
(43) Pub. Date: Mar. 5, 2026

(54) VELOCITY MEASURING APPARATUS

(71) Applicant: KOREA AEROSPACE RESEARCH INSTITUTE, Daejeon (KR)

(72) Inventors: DONG MIN KIM, Daejeon (KR); Joongwon Bae, Daejeon (KR)

(21) Appl. No.: 19/315,001

(22) Filed: Aug. 29, 2025

(30) Foreign Application Priority Data
Aug. 30, 2024 (KR) 10-2024-0117663

(51) Int. Cl. G01P 3/12

(52) U.S. Cl. CPC G01P 3/12

(57) ABSTRACT

The present disclosure relates to a velocity measuring apparatus. An embodiment of the present disclosure is directed to providing a velocity measuring apparatus capable of measuring a velocity of a target object by using only a portable device capable of detecting noise and vibration, without installing any separate signal generator for the measurement. More particularly, an embodiment of the present disclosure is directed to providing a velocity measuring apparatus for measuring a velocity from only two or more noise or vibration events that inevitably accompany the passage of a target object, and for detecting noise and/or vibration and calculating a section velocity by using only a single computation unit.

### CROSS-REFERENCE TO RELATED APPLICATIONS

This application claims priority under 35 U.S.C. §119 to Korean Patent Application No. 10-2024-0117663, filed on August 30, 2024, in the Korean Intellectual Property Office, the disclosure of which is incorporated herein by reference in its entirety for all purposes.

### TECHNICAL FIELD

The following disclosure relates to a velocity measuring apparatus for measuring a velocity of a target object based on a sound event or a vibration event generated by the target object.

### BACKGROUND

It is often necessary to measure a velocity of a target object undergoing a motion of position change, such as a vehicle or a ball, when the object passes a specific point. A velocity value measured in this way may be used for various purposes. The utility of velocity values is significantly diverse. For example, the measured velocity of the target object may serve as a criterion for determining whether the velocity satisfies a specific standard. The velocity value may also be used to predict a future behavior of the target object. Accordingly, methods for measuring a velocity of a target object in motion have been developed in various ways.

Meanwhile, many people enjoy golf as a hobby, and have considerable interest in various equipment to improve their skills. Most of these users are interested in putting practice. While the most comprehensive practice is possible on the green, access to the green is not always possible, leading to the widespread use of an indoor putting practice device. The indoor putting practice device has traditionally been marketed for short-distance putting, particularly for directional practice, rather than mid- to long-distance putting due to space constraints. Recently, however, a new device utilizing velocity measurement technology has been released to assist a player in acquiring a sense of distance for the mid- to long-distance putting, even in a confined space. Most of these putting practice devices essentially measure a ball velocity and provide a calculated roll distance of the ball based on experimental data. In general, velocity measurement may be accomplished using a variety of methods, such as video cameras, lasers, ultrasound, and magnetic sensors. The advantages and disadvantages of each method are briefly described below.

When using a video camera, the motion of a target object is captured at high speed, and a velocity vector is calculated based on position coordinate conversion of a video image and dynamic behavior analysis. With the widespread commercialization of such cameras, velocity measurement technology using video analysis has become considerably more sophisticated. This method of velocity measurement may offer various advantages, such as high precision, direction prediction, and the ability to analyze a ball motion when used to measure a velocity of a golf ball or the like. However, installing a camera to capture the target object requires a separate space, and its installation location may be limited. Arbitrary installation is also difficult because a positional relationship between the target object or a target region and the camera is necessary to be completely known in advance. Furthermore, an additional marking on the target object or the target region is necessary for accurate velocity measurement.

When using lasers or ultrasound, reflected or interrupted waves of the laser or ultrasound are utilized. A velocity of a target object may be measured by shooting ultrasound toward the target object and measuring a time required for the ultrasound to reflect back from the target object. Alternatively, a transmitter/receiver pair may be installed at a specific distance, and the signal interruption at a moment at which the target object passes through the transmitter/receiver pair may be recorded at each time point to measure a velocity of a target object. This method may also be applied to using general light, not necessarily lasers or ultrasound. For example, Korean Patent Laid-Open Publication No. 2014-0129652 ("Apparatus for Measuring Velocity of Golf Ball", November 7, 2014) discloses a technology for disposing light-receiving sensors at various positions on a base where a golf ball is placed and detecting when light is blocked due to a ball shadow to determine a ball position and calculate a ball velocity. The velocity measuring apparatus, which utilizes this principle, has an advantage of being able to be installed even between narrow spaces and enabling relatively accurate velocity measurement. However, such an apparatus essentially requires an additional device including a transmitter and a receiver, therefore making arbitrary measurement impossible.

When using impulse measurement, rather than calculating an expected distance by calculating the velocity, this method provides the expected distance by directly utilizing a correlation between an experimentally confirmed impulse and a corresponding actual distance, and is thus different from the velocity measurement method. However, when examined in terms of usage in a putting practice device, this method may provide distance and direction information by measuring an impact strength and an impact detection location. However, such a measurement device requires a lot of experimental data to increase accuracy and has limitations in accuracy. In addition, this device inevitably requires exposure to a predetermined impact strength as it is, and therefore has limitations in terms of reducing noise. Noise may be a particular issue when practicing at night.

When using a magnetic field sensor, a wire that induces a magnetic force is buried in a floor, and a target object, which is an electrically conductive object, is moved over the wire. This method allows a velocity of the target object to be measured by measuring a change in the magnetic field. However, this method still requires the installation of a floor including buried wires, making arbitrary measurement impossible, and in particular, short-distance measurements difficult, thereby making its application very limited. Furthermore, this method is incapable of measuring the target object if made of an electrically non-conductive material, i.e., a non-metallic material, significantly limiting a scope of a measurement target.

While various technologies for measuring the velocity of a target object have been disclosed, most of the technologies have the limitation of requiring specific and expensive equipment. The putting practice device requires additional equipment for the velocity measurement, which increases a price of the device itself. However, the various prior technologies described above essentially require equipment such as high-speed cameras, laser/ultrasonic transmitters/receivers, and the like depending on the respective methods. Therefore, achieving the velocity measurement without such a device is impossible. That is, even if the aforementioned prior technologies are utilized, it is still difficult for an individual to measure a velocity at a reasonably high level of accuracy by using only minimal equipment.

### [Related Art Document]

### [Patent Document]

(Patent Document 1) Korean Patent Laid-Open Publication No. 2014-0129652 ("Apparatus for Measuring Velocity of Golf Ball", November 7, 2014)

### SUMMARY

An embodiment of the present disclosure is directed to providing a velocity measuring apparatus capable of measuring a velocity of a target object by using only a portable device capable of detecting noise and vibration, without installing any separate signal generator for the measurement. More particularly, an embodiment of the present disclosure is directed to providing a velocity measuring apparatus for measuring a velocity from only two or more noise or vibration events that inevitably accompany the passage of a target object, or by generating additional arbitrary noise or vibration events to increase accuracy, and for detecting noise and/or vibration and calculating a section velocity by using only a single computation unit.

In one general aspect, a velocity measuring apparatus 100 includes: an object travel part 110 extending in one direction and forming a travel path of a target object 500; an object arrival part 120 disposed at one end of the object travel part 110 and causing the target object 500 traveling from a starting point 115 at the other end of the object travel part 110 to complete its travel by colliding with the object travel part 120; and a computation unit 150 detachably mounted on the object arrival part 120, detecting at least one of two or more noise or vibration occurring due to the target object 500 while traveling, and calculating a velocity of the target object 500 based on the detected signal and travel distance.

Here, the computation unit 150 may have a position predetermined on the object travel part 110 or the object arrival part 120, receive in advance, as a travel distance, a distance between measurement points formed to induce noise or vibration from the target object 500, recognize noise or vibration as a measurement signal by including a built-in acoustic sensor or gyro sensor, and calculate a velocity of the target object 500 based on a travel distance value and a time difference value between the measurement signals. In particular, here, the computation unit 150 and an assembly of the object travel part 110 and the object arrival part 120 may be formed as completely independent structures, and the computation unit 150 may be detachably mounted on the object arrival part 120 in a manner that the computation unit 150 is placed and mounted on the object arrival part 120 or the computation unit 150 placed on the object arrival part 120 is removed by being picked up therefrom. In addition, the computation unit 150 may recognize, as the measurement signal, noise detected when the target object 500 passes the measurement point or vibration detected when the target object 500 arrives at and collides with the object arrival part 120.

The object travel part 110 may include a bottom part 111 extending in a length direction and formed as a plane parallel to the ground, and side wall parts 112 protruding in a height direction from both ends of the bottom part 111 in a width direction, when the extension direction of the object travel part 110 is referred to as the length direction, a direction intersecting the object travel part 110 is referred to as the width direction, a direction perpendicular to the length direction or the width direction is referred to as the height direction, a side toward the starting point 115 is referred to as the front, and a side toward the object arrival part 120 is referred to as the rear.

The object arrival part 120 may include a travel blocking part 121 fixed thereto and blocking the travel of the target object 500 by colliding with the target object 500 while traveling.

In addition, the object arrival part 120 may include a noise absorbing part 122 partially absorbing impact and noise occurring when the target object 500 collides with the travel blocking part 121.

In addition, the object arrival part 120 may include a device accommodating part 123 formed in a groove shape in the travel blocking part 121 and accommodating the computation unit 150.

Here, the measurement signal may include at least two selected from noise occurring when the target object 500 is struck upon departure, noise occurring when the target object 500 passes the measurement point, vibration occurring when the target object 500 arrives at the object arrival part 120, and the velocity measuring apparatus 100 may further include a noise generating part 130 generating noise when the target object 500 passes thereover.

Here, as the noise generating part according to the first embodiment, the noise generating part 130 may include a plurality of bottom lines 131 formed in shapes of mountains or valleys on a travel plane on which the target object 500 travels, and spaced apart from each other in the length direction.

Here, the noise generating part 130 may include a plurality of bottom lines 131 extending in the width direction, all of which are parallel to each other and have both ends extending to the pair of side wall parts 112.

Alternatively, the noise generating part 130 may include a plurality of bottom lines 131 extending in the width direction, all of which are parallel to each other. However, the lengths of the plurality of bottom lines 131 in the width direction may be shorter than their lengths between the pair of side wall parts 112 in the width direction, and different numbers of bottom lines 131 may be arranged in each region defined along the width direction.

Alternatively, the noise generating part 130 may include each of the plurality of bottom lines 131 having a different angle relative to the width direction, all of which have both ends extending to the pair of the side wall parts 112.

Alternatively, as the noise generating part according to the second embodiment, the noise generating part 130 may include a separation line 132 extending in the width direction, and separated from the travel plane on which the target object 500 travels.

Here, the noise generating part 130 may include the separation line 132 causing noise by vibrating itself when the target object 500 passes over the separation line 132 or by allowing the target object 500 to be caught by the separation line 132 and bounce off.

In addition, if the separation line 132 is disposed at a height close to a height of the target object 500, the noise generating part 130 may include: a fitting part 133 formed in the shape of a slit hole extending in the height direction and disposed in a support provided separately on each side of the object arrival part 120 or the side wall part 112, into which each end of the separation line 132 is fitted, and within which the separation line 132 is movable in the height direction; and a blocking part 134 provided at each end of the separation line 132 that passes through the slit hole to prevent the separation line 132 from escaping from the fitting part 133.

In addition, when a single noise generating part 130 is installed on the object travel part 110, the noise generating part 130 may be disposed near the front of the object arrival part 120 in the length direction. Alternatively, when a plurality of object travel parts 110 are provided, a selected one may be disposed near the front of the object arrival part 120 in the length direction, and the other object travel parts 110 may be distributed at predetermined positions in the length direction.

In addition, the object travel part 110 may further include a sound-absorbing part 113 made of a cotton material laid on the bottom part 111 and serving to partially absorb noise occurring when the target object 500 travels.

In addition, the object travel part 110 may be cut at at least one position in the length direction, and each cut portion may be connected to at least one hinge part 114. In this case, the object travel part 110 may be foldable by the hinge part 114.

In addition, the object arrival part 120 may include a travel guide part 124 formed in a predetermined path space shape and guiding the travel path of the target object 500.

More specifically, the travel guide part 124 may include an inflow region 124a formed as a straight path space including a bottom surface having one end in close contact with the bottom part 111 and having the same plane as the bottom part 111 or an inclined plane inclined relative to the bottom part 111 to allow the target object 500 to flow thereinto, and a collision region 124b formed as a straight or curved path space to guide the target object 500 to travel toward and collide with the travel blocking part 121.

In addition, when a travel direction of the target object 500 in the inflow region 124a and a travel direction of the target object 500 in the collision region 124b are different from each other, the travel guide part 124 may include a transition region 124c formed between the inflow region 124a and the collision region 124b, formed as a curve path space, and serving to guide the travel direction of the target object 500 by continuously changing the travel direction.

As an example, the travel guide part 124 may include the transition region 124c formed in a semicircular shape, thereby forming the travel directions of the target object 500 in the inflow region 124a and the collision region 124b in the opposite directions.

As another example, the travel guide part 124 may include the transition region 124c formed in a quadrant shape or a fan shape. If the collision region 124b is formed as a straight path space, the travel direction of the target object 500 in the collision region 124b may be formed to be perpendicular to the bottom part 111. If the collision region 124b is formed as a curved path space having the same curvature as the transition region 124c, the travel direction of the target object 500 in the inflow region 124a may be formed in a tangential direction relative to a trajectory in the transition region 124c or the collision region 124b.

Here, if the collision region 124b is formed in a straight path space, the travel guide part 124 may include a variable region 124d formed between the transition region 124c and the collision region 124b to vary an extension length of the path space.

Meanwhile, the travel guide part 124 may include at least one object bouncing part 125 formed as a protrusion or a catching step to allow the target object 500 to be caught and bounce off when the target object 500 travels at a starting position of the collision region 124b.

Here, the travel guide part 124 may cause the target object 500, after passing the object bouncing part 125, to consume motion energy by colliding multiple times with the ceiling, floor, and travel blocking part 121 of the path space within the collision region 124b, thereby generating at least one time point at which a velocity component of the target object 500 in a travel direction becomes zero.

Other features and aspects will be apparent from the following detailed description, the drawings, and the claims.

### BRIEF DESCRIPTION OF THE DRAWINGS

FIG. 1 illustrates a full perspective view of a velocity measuring apparatus according to the present disclosure.

FIG. 2 illustrates noise and vibration measurement data for describing a velocity measurement principle according to the present disclosure.

FIG. 3 illustrates an enlarged view of the measurement data in FIG. 2.

FIG. 4 illustrates a perspective view of an object arrival part of the velocity measuring apparatus according to a first embodiment of the present disclosure.

FIG. 5 illustrates a cross-sectional view of the object arrival part of the velocity measuring apparatus according to the first embodiment of the present disclosure.

FIG. 6 illustrates a noise generating part according to a first embodiment of the present disclosure.

FIG. 7 illustrates a noise generating part according to a second embodiment of the present disclosure.

FIGS. 8 and 9 illustrate cross-sectional views of an object arrival part of the velocity measuring apparatus according to a second embodiment of the present disclosure.

FIG. 10 illustrates a cross-sectional view of an object arrival part of the velocity measuring apparatus according to a third embodiment of the present disclosure.

FIG. 11 illustrates a cross-sectional view of an object arrival part of the velocity measuring apparatus according to a fourth embodiment of the present disclosure.

FIGS. 12 and 13 illustrate cross-sectional views of an object arrival part of the velocity measuring apparatus according to a fifth embodiment of the present disclosure.

### DETAILED DESCRIPTION OF EMBODIMENTS

Hereinafter, a velocity measuring apparatus having the above-described configuration and a velocity measuring method according to the present disclosure are described in detail with reference to the accompanying drawings.

### [1] Basic configuration of the velocity measuring apparatus according to the present disclosure

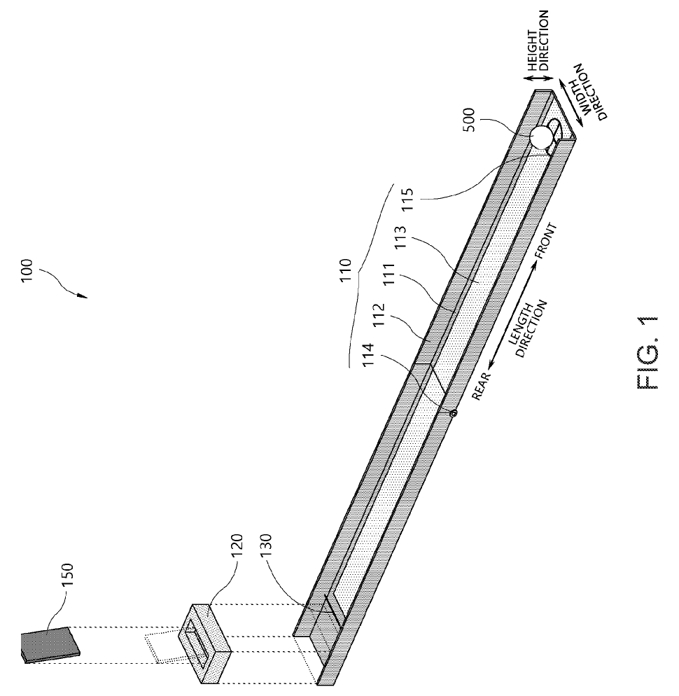

FIG. 1 illustrates a full perspective view of the velocity measuring apparatus according to the present disclosure. A velocity measuring apparatus 100 according to the present disclosure may basically include an object travel part 110, an object arrival part 120, and a computation unit 150 as illustrated in FIG. 1. The velocity measuring apparatus 100 may generate two or more noise or vibration events that inevitably accompany the passage of a target object, and may detect noise and/or vibration and calculate a section velocity by using only a single computation unit capable of performing computation. As inferred from a shape of the velocity measuring apparatus 100 according to the present disclosure illustrated in FIG. 1, the velocity measuring apparatus 100 according to the present disclosure may be utilized as a putting practice device in golf.

Here, the velocity measuring apparatus 100 may further include a noise generating part 130 in order for the computation unit 150 to more effectively detect noise. A configuration of the noise generating part 130 is described in more detail in the following embodiments, and a basic configuration of the velocity measuring apparatus 100 is first described.

As illustrated in FIG. 1, the object travel part 110 may extend in one direction and serve to form a travel path of a target object 500. To describe more specifically, the direction is first defined: the extension direction of the object travel part 110 is referred to as a length direction; a direction intersecting the object travel part 110 is referred to as a width direction; a direction perpendicular to the length direction or the width direction is referred to as a height direction; a side toward a starting point 115 is referred to as the front; and a side toward the object arrival part 120 is referred to as the rear. Here, the object travel part 110 may basically include a bottom part 111 and a pair of side wall parts 112. The bottom part 111 may extend in the length direction, be formed as a plane parallel to the ground to form a bottom surface on which the target object 500 may travel while rolling, and have the starting point 115, which is a point from which the target object 500 departs, indicated thereon. On the bottom surface, the side wall parts 112 may protrude in the height direction from both ends of the bottom part 111 in the width direction, thereby preventing the target object 500 from escaping outward from a region of the bottom part 111.

In addition, the object travel part 110 may further include a sound-absorbing part 113 and a hinge part 114. The sound-absorbing part 113 may be made of a cotton material laid on the bottom part 111 and serve to partially absorb noise occurring when the target object 500 travels. Meanwhile, the velocity measuring apparatus 100 is described above as being usable as the putting practice device in golf. Considering this feature, the sound-absorbing part 113 may have a shape of grass to simulate and implement a frictional force occurring on a golf course green. In addition, the object travel part 110 may be cut at least one position in the length direction, and each cut portion may be connected to at least one hinge part 114. In this case, the object travel part 110 may be foldable by the hinge part 114, thereby improving user convenience in storing or moving the velocity measuring apparatus 100.

The object arrival part 120 may be disposed at one end of the object travel part 110 and serve to cause the target object 500 traveling from the starting point 115 at the other end to complete its travel by colliding therewith. That is, the target object 500 may roll along the object travel part 110 and be stopped by the object arrival part 120 to complete its travel. In FIG. 1, the object arrival part 120 is illustrated as having a very simple form and including only of a single mass body that serves to stop the target object 500, and the present disclosure is not limited thereto. Embodiments described hereinafter with reference to the drawings are intended to specifically describe various types of the noise generating part 130 or the vibration transmitting part 140, as described above. A more specific and detailed configuration of the object arrival part 120 is illustrated in the drawings below. For reference in advance, the specific configuration of the object arrival part 120 is described as follows.

The object arrival part 120 may basically serve to block and stop the travel of the target object 500. Therefore, as illustrated in FIG. 1 as a minimum configuration and in all subsequent drawings, the object arrival part 120 may include a travel blocking part 121 that is provided as the most basic component and fixed thereto to prevent the travel of the target object 500 by colliding with the traveling target object 500. The travel blocking part 121 is only required to block the travel of the target object 500, and may thus only need to be firmly fixed to the object travel part 110 in the form of a rail. However, considering that the target object 500 may collide countless times with the travel blocking part 121 while using the velocity measuring apparatus 100, if the travel blocking part 121 is simply fixed to the object travel part 110, the travel blocking part 121 may have a reduced durability or a reduced lifespan due to a fatigue impact caused by repeated collisions applied to a fixed connection part. Here, if formed to have a sufficiently heavy mass, the travel blocking part 121 may withstand the collision with the target object 500 without being pushed out due to a fixing frictional force even without a separate fixation. That is, if formed to have a sufficiently heavy mass and be fixed to the object travel part 110, the travel blocking part 121 may effectively overcome the reduced durability or lifespan due to fatigue impact occurring at the fixed connection part.

Meanwhile, the target object 500 may inevitably collide with the object arrival part 120, thus inevitably causing noise. This collision noise is necessary because such noise is required to be used as an arrival signal.

However, as described above, when the velocity measuring apparatus 100 is used as the putting practice device, this environmental noise may cause discomfort to surrounding people, and it is thus necessary to suppress the occurrence of excessive noise to an appropriate degree. In addition, the object arrival part 120 may be damaged due to accumulated fatigue impacts as the target object 500 repeatedly collides with the object arrival part 120. Considering these features, the object arrival part 120 may preferably include a noise absorbing part 122 for partially absorbing the impact and noise occurring when the target object 500 collides with the travel blocking part 121, as illustrated in the drawings below. The noise absorbing part 122 may be made of a relatively flexible elastic material to prevent the occurrence of excessive impact or noise even during the collision. The travel blocking part 121 itself may be made of a flexible elastic material. In such a case, as illustrated in FIG. 1, the travel blocking part 121 and the noise absorbing part 122 may be formed as one component, i.e., as an integral component, rather than separate components. However, as described above, the travel blocking part 121 may preferably be formed as the mass body that is sufficiently heavy not to be pushed out even during the collision in order to prevent fatigue occurring at the fixed connection part. However, it is considerably difficult to find a material that is sufficiently heavy, flexible, and elastic. Therefore, as illustrated in the drawings below, the travel blocking part 121 and the noise absorbing part 122 may preferably be formed as separate components.

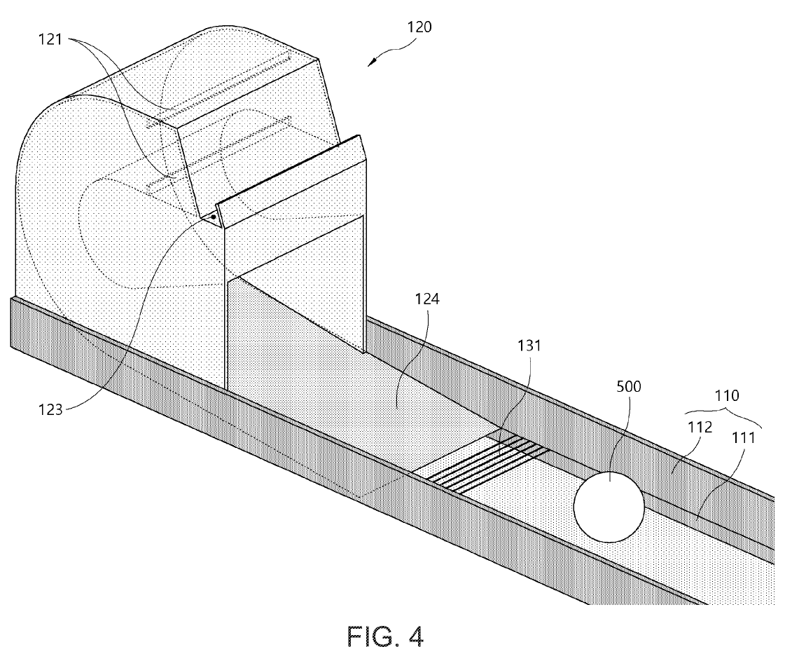

In addition, the object arrival part 120 may also serve to accommodate the computation unit 150. As the simplest form in which the computation unit 150 may be accommodated, as illustrated in FIGS. 1 and 4, a device accommodating part 123 may be formed on the object arrival part 120. More specifically, the device accommodating part 123 may have a groove shape in the travel blocking part 121 to accommodate the computation unit 150. However, if the object arrival part 120 includes the travel blocking part 121 and the noise absorbing part 122 formed as an integral component, the following concerns may arise. That is, if the target object 500 collides with the object arrival part 120 while the computation unit 150 is accommodated in the device accommodating part 123, the object arrival part 120 may be deformed and the computation unit 150 may be damaged due to excessive vibration. On the other hand, this issue may be prevented if the object arrival part 120 includes the travel blocking part 121 and the noise absorbing part 122, which are separate components and assembled to each other. Therefore, in this case, the device accommodating part 123 may be formed on the travel blocking part 121 to easily mount the computation unit 150 thereon.

The computation unit 150 may be detachably mounted on the object arrival part 120, and serve to detect at least one of two more noises or vibrations occurring due to the target object 500 while traveling, and to calculate a velocity of the target object 500 based on the detected signal and travel distance. That is, the computation unit 150 may comprehensively perform all functions of various sensors and analysis units included in a general velocity measuring apparatus.

The functions of the computation unit 150 are described in more detail as follows. The computation unit 150 may have its position predetermined on the object travel part 110 or the object arrival part 120, and receive in advance, as the travel distance, a distance between measurement points formed to induce noise or vibration from the target object 500. In addition, the computation unit 150 may include a built-in acoustic sensor or gyro sensor, and recognize, as a measurement signal, noise detected when the target object 500 passes the measurement point or vibration detected when the target object 500 arrives at and collides with the object arrival part 120. The measurement signal may be more specifically specified as a departure signal if generated at the starting point or the arrival signal if generated at an arrival point. Based on this information, the computation unit 150 may calculate the velocity of the target object 500 based on a travel distance value and a time difference value between the measurement signals. A velocity value calculated in this way may be output to a user as it is. Alternatively, if the velocity measuring apparatus 100 is used as the putting practice device, a putting distance may be calculated based on the velocity value and output to the user.

An implementation form of the computation unit 150 is described in more detail as follows. In the present disclosure, the computation unit 150 and an assembly of the object travel part 110 and the object arrival part 120 may be provided as completely independent structures, and the computation unit 150 may then be detachably mounted on the object arrival part 120. In addition, the attachment or detachment of the computation unit 150 according to the present disclosure may be performed by simply mounting the computation unit 150 on the object arrival part 120 by placing the computation unit 150 on the object arrival part 120 or detaching the computation unit 150 placed on the object arrival part 120 by picking the computation unit 150 up therefrom, without requiring any separate assembly structure or satisfying any standards. That is, according to the present disclosure, the object travel part 110 or the object arrival part 120, which is a mechanical structure in which the target object 500 actually travels, does not need to include any electronic device for detection. In other words, the assembly of the object travel part 110 and the object arrival part 120 may include only purely mechanical structures.

Meanwhile, the computation unit 150 is required to include the built-in acoustic sensor or gyro sensor as described above to perform the sensor function. In addition, the computation unit 150 is required to have a computational ability such as calculating the velocity based on a time required to detect noise or vibration to perform the function of the analysis unit. Considering these functions of the computation unit 150, a dedicated device may be manufactured using an acoustic sensor, a gyro sensor, a central processing unit (CPU), or the like. Meanwhile, a smartphone is a device including both the sensor and the computational ability, and widely carried by most of a general public in Korea. That is, the computation unit 150 of the velocity measuring apparatus 100 according to the present disclosure may be easily implemented by installing an application, which is software that uses a detection and computation algorithm matching the present disclosure, on a smartphone.

Considering the above matters comprehensively, if commercialized, the velocity measuring apparatus 100 according to the present disclosure may be provided in a form to include hardware such as the object travel part 110 and the object arrival part 120, as well as software that utilizes the detection and computation algorithm. In this case, the hardware does not require any relatively expensive components such as sensors or computation chips, thereby significantly reducing production costs. That is, the user may purchase the hardware as a physical product constructed as a purely mechanical structure without any electronic equipment and utilize this product as the computation unit 150 by installing the software corresponding to the present disclosure on an existing smartphone of the user. Even if the software is purchased as a paid application, a cost of the software is clearly much lower than a component cost of the electronic equipment. In this way, implementing the present disclosure into an actual commercial product may significantly reduce the product cost, thus resulting in significant economic benefits to the user.

### [2] Velocity measurement method and principle according to the present disclosure

Hereinafter, the velocity measurement method and principle using the velocity measuring apparatus 100 according to the present disclosure are described in more detail.

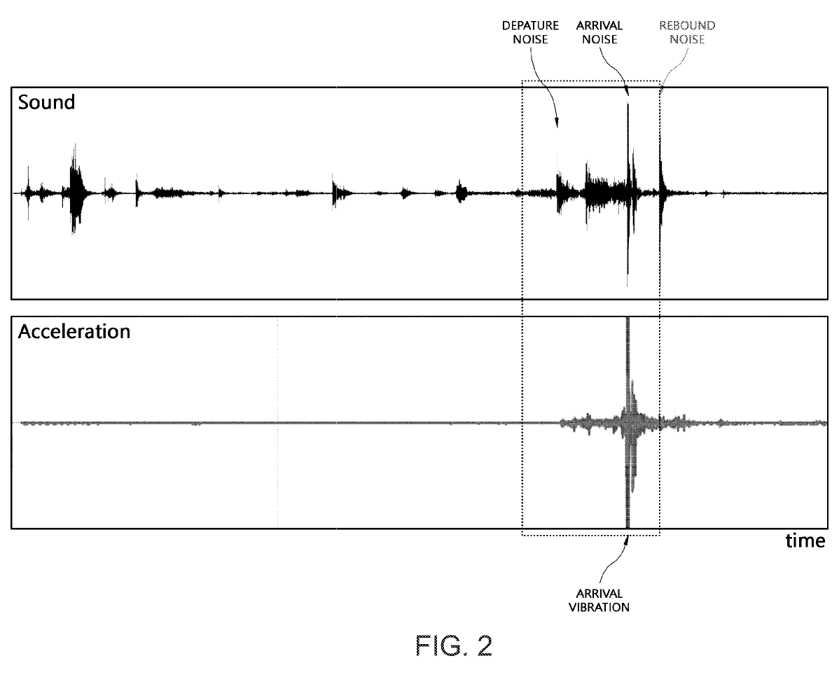

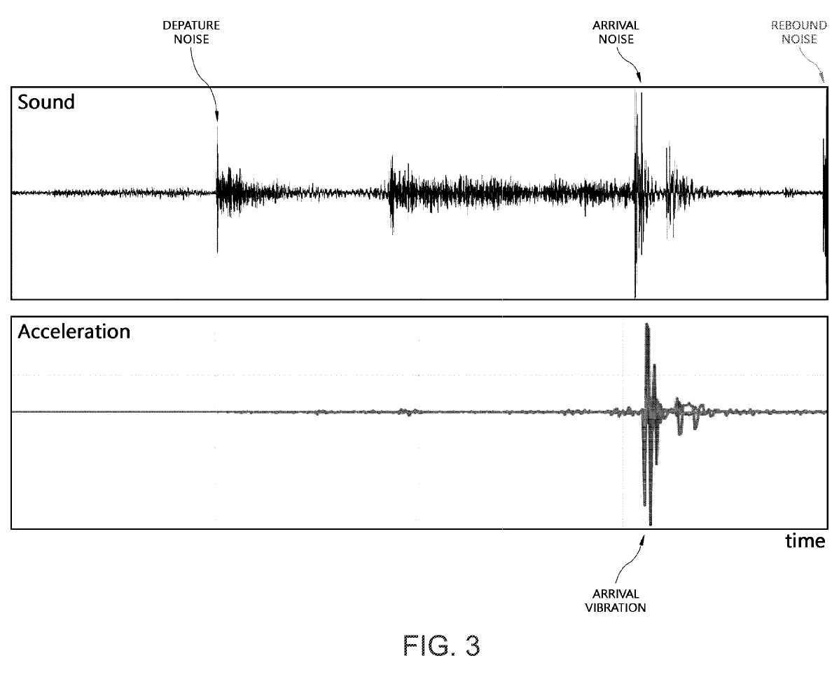

The velocity measurement method according to the present disclosure may include an object departure step, a departure recognition step, an object arrival step, an arrival recognition step, and a velocity calculation step, and may further include a distance calculation step. In addition, a noise removal operation may be further performed in the departure recognition step or the arrival recognition step. FIG. 2 illustrates noise and vibration measurement data as an example used to describe the velocity measurement principle according to the present disclosure; and FIG. 3 illustrates an enlarged view of the measurement data in a region indicated by a dotted box in FIG. 2. Referring to FIGS. 2 and 3, each step included in the velocity measurement method according to the present disclosure is described in more detail.

In the object departure step, the target object 500 may depart and travel toward the object arrival part 120 by being struck while being disposed at the starting point 115. As described above, the velocity measuring apparatus 100 may be utilized as the putting practice device. Here, the target object 500 may be a golf ball. In this case, the user may place the target object 500, which is a golf ball, at the starting point 115 (indicated on the object travel part 110) and strike the target object 500 using a golf club, thereby allowing the target object 500 to start its travel.

In the departure recognition step, noise occurring when the target object 500 departs in the travel departure step may be detected by the computation unit 150 and recognized as the departure signal. As described above, the departure may occur at a moment at which a golf ball is struck using a golf club. Here, a striking noise inevitably occurs, and this noise may be captured as the departure signal. A peak value indicated as "departure noise" in FIGS. 2 and 3 may refer to the departure signal.

Meanwhile, in the departure recognition step, if the user practices putting in a private space, there is no room for noise interference.

However, if other people are present in the space and cause environmental noise, another noise may be confused as the departure signal, resulting in misrecognition. A method for removing noise from the departure signal may utilize the magnitude or frequency of noise. When a golf ball strikes a golf club, a fairly loud "click" noise may be produced, and an average magnitude of this striking noise may be experimentally obtained in advance. It is apparent that a magnitude of another noise, such as a footstep of another nearby user or a striking noise of another user at a distance, is smaller than the striking noise occurring by the user himself or herself. Therefore, any noise smaller than the experimentally obtained and predetermined striking noise may be considered another noise. Alternatively, a golf ball or a golf club is predetermined to be made of roughly the same material, and a frequency of noise occurring during their collision is also known in advance to be approximately 1000 to 1800 Hz. Therefore, noise that falls outside this frequency band may be considered another noise. In summary, in the departure recognition step, the computation unit 150 may recognize and ignore noise as another noise if noise detected by the computation unit 150 has a magnitude smaller than the predetermined reference magnitude or if a frequency of noise detected by the computation unit 150 falls outside the predetermined reference frequency band.

In the object arrival step, the target object 500 may travel along the object travel part 110 and arrive at the object arrival part 120. As described above, the travel of the target object 500 may be stopped when the target object 500 collides with the object arrival part 120, and this moment of collision may become a moment at which the target object 500 arrives at the object arrival part 120. Meanwhile, in relation to such a motion of the target object 500, information such as a position of the starting point 115, a specification of the object travel part 110, and a position of the object arrival part 120 may all be known in advance, thus allowing the distance that the target object 500 travels to be substantially known in advance.

In the arrival recognition step, when the target object 500 arrives at the object arrival part 120 in the object arrival step, at least one of noises or vibrations occurring upon the arrival at the object arrival part 120 may be detected by the computation unit 150 and recognized as the arrival signal. Meanwhile, as described above, the object arrival part 120 may include the noise absorbing part 122 to prevent excessive noise. In this case, the collision between the target object 500 and the object arrival part 120 itself may not cause a large amount of noise. In this case, it may be difficult to determine an arrival time point based only on a noise signal. Therefore, a separate noise generating part 130 may be disposed near the object arrival part 120 to generate specific noise, thereby allowing the arrival signal to be more easily obtained.

Meanwhile, the arrival recognition step also needs to distinguish noise, and unlike the departure recognition step, time may be used instead of the noise magnitude or frequency. As described above, the travel distance of the target object 500 is a value known in advance, and the velocity of the target object 500 (e.g., a golf ball) obtained during putting may also be a value that varies only within a predetermined range and is capable of being obtained experimentally in advance. Here, if struck too lightly, a golf ball may stop before reaching the object arrival part 120. That is, the user is required to strike a ball sufficiently hard to actually reach the object arrival part 120, which derives a [minimum velocity], which is a threshold value. Using this minimum velocity value obtained experimentally in advance and a travel distance value, which is also obtained in advance based on the device specification or the like, a [maximum time] required to travel the entire travel distance when the minimum velocity is applied may be calculated. A maximum time value may also be obtained in advance, and serve as another threshold value, similar to the fact that the minimum velocity being a threshold value. If noise occurs within the maximum time from the departure signal, this noise may be an arrival signal. However, if noise occurs after the maximum time, this noise does not correspond to the arrival signal. It is confirmed from the above description that a golf ball is incapable of rolling for a time longer than the maximum time, and accordingly, noise occurring after the maximum time is not the arrival signal but a different noise, that is, another noise. Based on this logic, in the arrival recognition step, the computation unit 150 may recognize and ignore such noise as another noise if a time difference between the departure and arrival signals detected by the computation unit 150 is greater than a predetermined maximum time difference.

In addition, FIGS. 2 and 3 illustrate "rebound noise." The target object 500 may collide with the object arrival part 120 and then rebound back a short distance. During this rebound process, the target object 500 may come into contact with the noise-generating part again, thus causing noise referred to as rebound noise. Meanwhile, vibration may occur only by the collision, and accordingly, even if rebound noise occurs, no vibration considered meaningful may occur at this moment. Rebound noise may usually occur at a time point after the maximum time, and may thus be automatically regarded and ignored as another noise based on the criterion described above. Alternatively, if noise and vibration are measured together, the criteria may be set to regard only a combination of [noise + vibration] as the arrival signal. In this case, no vibration occurs, and rebound noise may thus also be automatically regarded and ignored as another noise.

In the velocity calculation step, the computation unit 150 may calculate the velocity of the target object 500 based on the travel distance value and the time difference value between the departure signal and the arrival signal. As described above, the travel distance is the value known in advance, and the times at which the departure and arrival signals occur are both known, as illustrated in FIGS. 2 and 3, and the velocity value may thus be calculated very easily.

Meanwhile, as described above, the computation unit 150 may include the acoustic sensor for noise measurement, the gyro sensor for vibration measurement, and the computational ability for velocity calculation, and may be a smartphone, which is a device widely carried by the general public. That is, by simply installing the steps described above in the form of a software application on a smartphone, any smartphone may be easily operated as the computation unit 150. When the velocity measuring apparatus 100 is utilized as the putting practice device, the computation unit 150 may output not only the velocity but also the putting distance at the corresponding velocity. That is, the distance calculation step may further be performed after the velocity calculation step.

In general, a relationship between the velocity and the putting distance when striking a golf ball is well known to be used even in a database of a currently commercialized product. New experiments may also be performed to provide a new database. In any case, the database for the relationship between the velocity and the putting distance is a value obtained in advance. When the computation unit 150 receives in advance the database for the relationship between the velocity and the putting distance, in the distance calculation step, the computation unit 150 may calculate the putting distance based on the velocity calculated in the velocity calculation step and the database. In this case, the user may immediately check not only the velocity of a golf ball but also the putting distance when striking a golf ball at the corresponding velocity, which significantly assist the user in putting practice.

### [3] Embodiment of the velocity measuring apparatus according to the present disclosure: Noise generating part

The velocity measuring apparatus 100 according to the present disclosure may detect the departure/arrival of the target object 500 based on noise or vibration as described above. More specifically, in the velocity measuring apparatus 100 according to the present disclosure, the measurement signal may include at least two selected from noise occurring when the target object 500 is struck upon departure, noise occurring when the target object 500 passes the measurement point, and vibration occurring when the target object 500 arrives at the object arrival part 120.

The measurement point is usually the starting point or the arrival point. However, an additional measurement point may be placed between the starting/arrival points, if necessary.

In addition, various modifications of the measurement point are possible, such as using one of the measurement signals as the departure signal by setting the starting point to generate the same type of noise as that occurring at a general measurement point rather than using striking noise at departure as the departure signal.

Here, in order for the computation unit 150 to accurately detect noise, the velocity measuring apparatus 100 may further include the noise generating part 130 generating noise when the target object 500 passes thereover.

FIGS. 4 to 7 illustrate the object arrival part of the velocity measuring apparatus 100 according to the first embodiment of the present disclosure, and the noise generating part of the velocity measuring apparatus 100 according to the first or second embodiment of the present disclosure. FIGS. 4 to 7 illustrate that the noise generating part 130 according to several embodiments is disposed in the object arrival part according to the first embodiment, and the present disclosure is not limited thereto. In other words, the noise generating part 130 described herein may be applied to an object arrival part according to various other embodiments described below in addition to the object arrival part according to the first embodiment.

3-1. Noise generating part according to the first embodiment

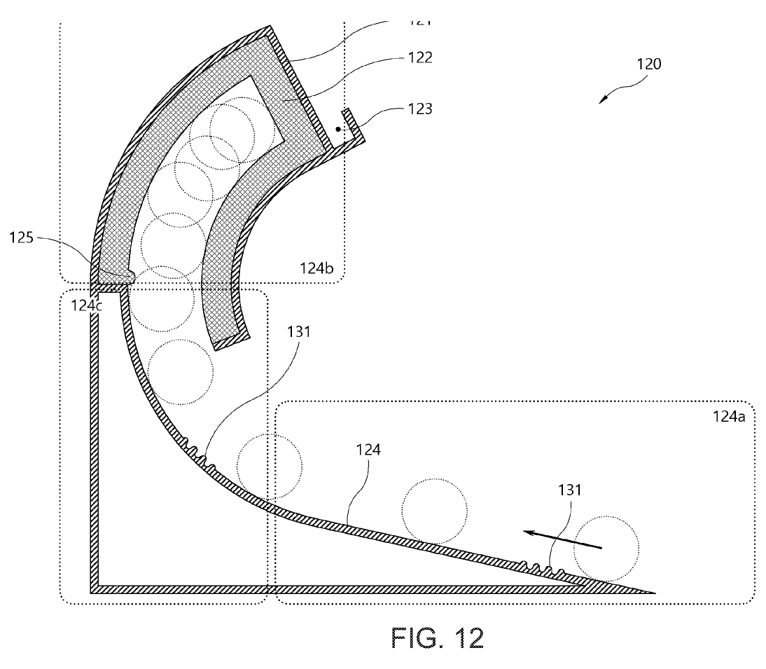

FIG. 4 illustrates the noise generating part 130 according to the first embodiment. In the noise generating part according to the first embodiment, as illustrated in FIG. 4, the noise generating part 130 may include a plurality of bottom lines 131 formed in shapes of mountains or valleys on a travel plane on which the target object 500 travels, and spaced apart from each other in the length direction. FIG. 4 and the subsequent drawings illustrate that the bottom line 131 is formed on the bottom part 111 of the object travel part 110. However, as illustrated in FIG. 12, which illustrates a cross-sectional view of the object arrival part according to a fifth embodiment described below, the bottom line 131 may be formed on the object arrival part 120. That is, the bottom line 131 may be formed anywhere, whether on the object travel part 110 or the object arrival part 120, as long as, the bottom line 131 serves as the travel plane on which the target object 500 travels.

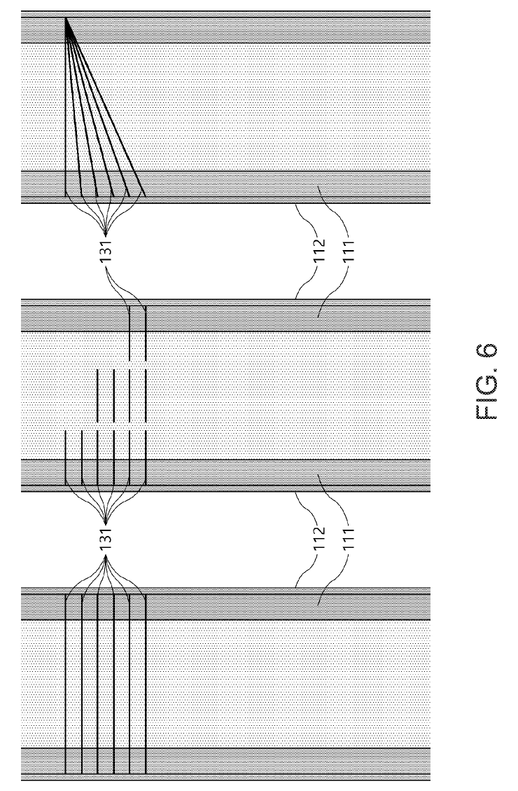

Accordingly, when the target object 500 rolls through a region where the bottom lines 131 are formed, specific noise different from that in another region may occur. A pattern of this specific noise may be designed in advance based on the shape or arrangement of the bottom line 131, and by inputting this noise pattern in advance into the computation unit 150, this specific noise may be easily detected as the arrival signal. A feature of this noise may be determined based on the shape of the bottom line 131. That is, measurement signal noise may be set based on the shape of the bottom line 131 or measurement signal noise may be analyzed to determine whether corresponding noise is the measurement signal such as the departure/arrival signal. FIG. 6 illustrates various modifications of the noise generating part 130 including the plurality of bottom lines 131. As described above, noise varies depending on the shape of the bottom line 131. Therefore, additional analysis results, such as left-right bias measurement, may be obtained by imparting desired feature to noise based on the shape.

The noise generating part 130 on a left side of FIG. 6 has the same shape as illustrated in FIG. 4, and this shape corresponds to the most basic shape of the noise generating part according to the first embodiment. In this case, the noise generating part 130 may include a plurality of bottom lines 131 extending in the width direction, all of which are parallel to each other and have both ends extending to the pair of the side wall parts 112. In the drawing, six of the bottom lines 131 are illustrated as being equally spaced in the length direction. However, the number or spacing of bottom lines may be appropriately changed, if necessary. A specific example of this case is as follows. If the target object 500 passes over one of the bottom lines 131 and makes a "tap" sound, six consecutive noises such as "tap, tap, tap, tap, tap, tap" may occur at a regular cycle when six bottom lines 131 are provided, all of which are equally spaced apart from each other, as illustrated on the left side of FIG. 6. That is, if this type of noise (six peaks + regular cycle) is detected, this noise may be determined as the measurement signal.

The noise generating part 130 on a middle side of FIG. 6 is similar to the left side of FIG. 6. However, the middle side may be divided into regions along the width direction, and different number of bottom lines 131 may be arranged in each region. In summary, while the middle side of FIG. 6 basically illustrates a plurality of parallel lines, which is the same as the left side, the number of parallel lines varies depending on their positions in the width direction. Specifically, similar to the left side of FIG. 6, on the middle side of FIG. 6, the plurality of bottom lines 131 may extend in the width direction, all of which are parallel to each other. However, unlike the left side of FIG. 6, the lengths of the plurality of bottom lines 131 in the width direction may be shorter than their lengths between the pair of the side wall parts 112 in the width direction. Here, different numbers of bottom lines 131 may be arranged in each region defined along the width direction, resulting in different noise patterns depending on the left-right bias of the target object 500 in the width direction. That is, based on the middle side of FIG. 6, the target object 500 may generate six specific noises, "tap, tap, tap, tap, tap, tap" if biased to the left while traveling, generate four specific noises, "tap, tap, tap, tap" if traveling through the middle, and generate two specific noises, "tap, tap" if biased to the right while traveling. That is, it is possible to easily determine to which side the target object 500 is biased while traveling, e.g., to the left or right side, based on the noise pattern such as the number of peaks.

While also allowing the left-right bias to be recognized like the noise generating part 130 illustrated on the middle side of FIG. 6, the noise generating part 130 on a right side of FIG. 6 illustrates a different spacing between the bottom lines 131 at respective positions when viewed in the width direction. That is, specifically, each of the plurality of bottom lines 131 may have a different angle relative to the width direction, all of which have both ends extending to the pair of the side wall parts 112. In this case, regardless of whether the target object 500 is biased to the left or the right, the same six consecutive noises such as “tap, tap, tap, tap, tap, tap” may occur. However, an interval between the “tap” sounds becomes longer as the target object 500 is biased to the left and shorter as the target object 500 is biased to the right, thereby enabling the left or right bias of the target object 500 to be easily distinguished. Unlike the middle side of FIG. 6, where the left-right bias may only be determined by region such as left/middle/right, on the right side of FIG. 6, a degree of the left-right bias may be derived based on a time interval between specific noises occurring when the target object 500 passes over each of the bottom lines 131. In summary, the velocity of the target object 500 may first be calculated based on the departure or arrival signal, the interval between the bottom lines 131 on the path along which the target object 500 passes may then be calculated based on the velocity of the target object 500 and the time interval between specific noises in the arrival signal, and the position of the target object 500 in the width direction where the interval between the bottom lines 131 corresponds to the calculated value may then be determined.

### 3-2. Noise generating part according to the second embodiment

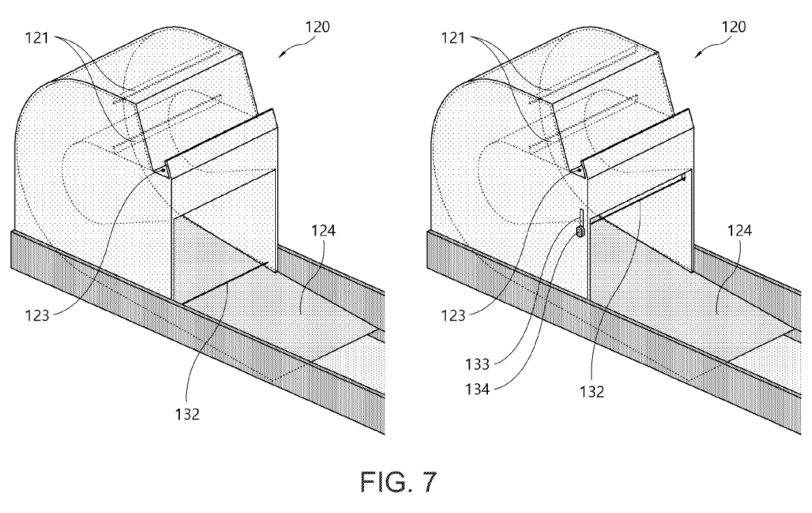

FIG. 7 illustrates the noise generating part 130 according to the second embodiment. The noise generating part according to the second embodiment may include a separation line 132 extending in the width direction and spaced apart from a travel plane on which the target object 500 travels, as illustrated in FIG. 6. By having this form, the separation line 132 itself may vibrate when the target object 500 passes over the separation line 132, or cause noise when the target object 500 is caught by the separation line 132 and bounces off.

In this way, if the noise generating part 130 is provided, collision noise occurring when the target object 500 collides with the object arrival part 120 may be reduced by the noise absorbing part 122 and may hardly occur. That is, noise may occur in the noise generating part 130 and utilized as the arrival signal, there is no need for causing collision noise.

Meanwhile, when viewed from a perspective of the object arrival part 120, impact and noise caused by the collision of the target object 500 may be effectively absorbed and mitigated by the noise absorbing part 122, and the travel blocking part 121 may maintain a considerably stable state. Accordingly, in this case, the groove-shaped device accommodating part 123 may be formed in the travel blocking part 121, and the computation unit 150 may then be accommodated therein. In this way, the computation unit 150 may be accommodated very stably even without any additional separate component.

The configuration of the noise generating part 130 according to the second embodiment may be more specifically examined as follows. As illustrated on the left side of FIG. 7, the noise generating part 130 may include the separation line 132 disposed near the bottom part 111 and cause noise by vibrating itself when the target object 500 passes over the separation line 132. This configuration may be considered to have a similar effect to the bottom line 131 of the noise generating part according to the first embodiment being slightly raised. However, in this configuration, the target object 500 may be caught by the separation line 132 and bounce off, which may significantly affect the velocity of the target object 500.

Meanwhile, as illustrated on a right side of FIG. 7, the separation line 132 may be disposed at a height close to a height of the target object 500, and may cause noise by allowing the target object 500 to be caught by the separation line 132 and bounce off. In particular, in this case, as illustrated on the right side of FIG. 7, the noise generating part 130 may preferably include: a fitting part 133 formed in the shape of a slit hole extending in the height direction and disposed in a support provided separately on each side of the object arrival part 120 or the side wall part 112, into which each end of the separation line 132 is fitted, and within which the separation line 132 is movable in the height direction; and a blocking part 134 provided at each end of the separation line 132 that passes through the slit hole to prevent the separation line 132 from escaping from the fitting part 133.

If the separation line 132 is installed to be freely movable in the height direction, the separation line 132 may be easily pushed up and passed when the target object 500 passes over the separation line 132, and the velocity or direction of the target object 500 may not be significantly affected. In addition, even if pushed up by the target object 500, the separation line 132 may easily return to its original position due to a weight of the blocking pat 134. More effective noise generation may be achieved when the blocking part 134 is made of a material that generates noise effectively.

### 3-3. The number of noise generating parts

The noise generating part 130 is basically used to cause noise when the target object 500 passes over. If the departure signal is set as striking noise and the arrival signal is measured based only on noise excluding vibration, a single noise generating part 130 may be essential to generate the arrival signal. However, the single noise generating part 130 does not necessarily have to be provided, and a plurality of noise generating parts 130 may be provided to measure the velocity of the target object 500 more accurately.

This configuration is described in more detail as follows. When a single noise generating part 130 is disposed on the object travel part 110, the noise generating part 130 may be disposed near the front of the object arrival part 120 in the length direction to generate the arrival signal.

Alternatively, when the plurality of object travel parts 110 are provided, a selected one may be disposed near the front of the object arrival part 120 in the length direction to generate the arrival signal, and the other object travel parts 110 may be distributed at predetermined positions in the length direction to generate intermediate signals. The position of the noise generating part 130 that generates the intermediate signal is predetermined, and by detecting the intermediate signals, the velocity of the target object 500 when passing each of the noise generating parts 130 may be calculated. Accordingly, a velocity change pattern during the travel of the target object 500 may be determined to some extent, thus allowing the velocity of the target object 500 to be measured more accurately. However, resistance to the motion of the target object 500 may occur when the target object 500 passes over the noise generating part 130, which may affect a final velocity of the target object 500, it is thus preferable not to provide too many noise generating parts 130 that generate the intermediate signals.

### [4] Embodiment of the velocity measuring apparatus according to the present disclosure: Object arrival part

FIG. 1 illustrates the most basic and simple form of the object arrival part 120 included in the velocity measuring apparatus 100 according to the present disclosure, and the function of each basic portion is described with reference to FIG. 1. However, in practice, in order to allow the arrival of the target object 500 to occur naturally while smoothly generating noise or vibration for measurement, the object arrival part 120 may preferably have a more improved form. That is, the object arrival part 120 in several embodiments described below does not merely serve to block the travel of the target object 500 by simply collision. The object arrival part 120 may include a travel guide part 124 formed in a predetermined path space shape that has a specific purpose and appropriately guiding the travel path of the target object 500. In the path space formed by the travel guide part 124, the above-described travel blocking part 121, noise absorbing part 122, device accommodating part 123, or the like may be appropriately disposed.

### 4-1. Object arrival part according to a first embodiment

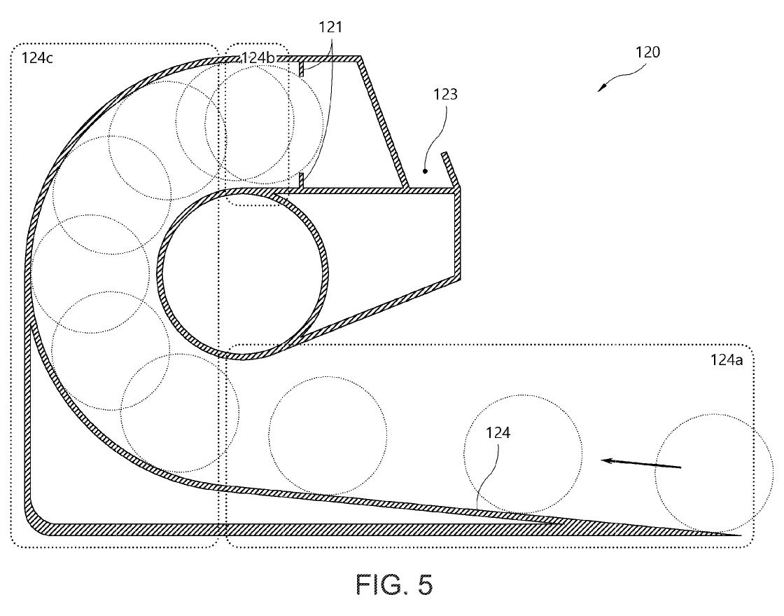

FIGS. 4 and 5 illustrate perspective and cross-sectional views of the object arrival part included in the velocity measuring apparatus according to the first embodiment of the present disclosure, respectively, and specifically describe a basic concept of the travel guide part 124 based on the object arrival part according to the first embodiment.

As described above, the travel guide part 124 may be formed as the predetermined path space and serve to guide the travel path of the target object 500.

Here, the object arrival parts according to the first embodiment as well as other embodiments to be described below commonly include the travel guide part 124, which necessarily includes an inflow region 124a allowing the target object 500 to flow thereinto, and a collision region 124b including the travel blocking part 121 and blocking the travel of the target object 500 by collision. That is, the inflow region 124a and the collision region 124b are all included in second and third extended embodiments described below.

The inflow region 124a refers to a region having one end in close contact with the bottom part 111, and formed as a straight path space to allow the target object 500 to flow thereinto. By including the inflow region 124a formed in this way, the target object 500 traveling along the object travel part 110 may naturally flow into the travel guide part 124. In particular, the bottom surface of the inflow region 124a may have the same plane as the bottom part 111 or an inclined plane inclined relative to the bottom part 111. As illustrated in FIG. 4, the object arrival part according to the first embodiment is an example in which the bottom surface of the inflow region 124a is formed as the inclined plane.

The collision region 124b refers to a region including the travel blocking part 121. Here, the travel blocking part 121 only needs to serve to block the target object 500 from traveling as described above, and may simply be formed in a wall shape or a catching structure that blocks an end of the path. Meanwhile, the collision region 124b itself may be formed as a straight or curved path space to naturally guide the target object 500 to travel toward and collide with the travel blocking part 121.

The inflow region 124a and the collision region 124b may be formed in the same direction (to add in advance, the object arrival part according to a fourth embodiment described below has this configuration), or may be formed in different directions. In the latter case, when a travel direction of the target object 500 in the inflow region 124a and a travel direction of the target object 500 in the collision region 124b are different from each other, the travel guide part 124 may further include a transition region 124c formed between the inflow region 124a and the collision region 124b. The transition region 124c may be formed as a curve path space and serve to guide the travel direction of the target object 500 by continuously changing the travel direction.

As illustrated in FIGS. 4 and 5, in the object arrival part according to the first embodiment, the travel direction of the target object 500 in the inflow region 124a and the travel direction of the target object 500 in the collision region 124b are formed to be opposite to each other. That is, as illustrated in FIG. 5, the path space forming the collision region 124b may be stacked on the path space forming the inflow region 124a. When viewed from a plane in the length direction and the height direction, the transition region 124c may form a semicircular path space having a lower end connected to the inflow region 124a and an upper end connected to the collision region 124b.

Referring to FIGS. 4 and 5, in the object arrival part according to the first embodiment, the travel blocking part 121 may be formed in the catching structure protruding from upper and lower portions of an inner space located at an end of the collision region 124b. The travel blocking part 121 may be formed as a blocking wall that completely blocks the end of the collision region 124b, and the shape of the travel blocking part 121 may be appropriately varied, if necessary.

In this type of object arrival part according to the first embodiment, the target object 500 may first flow into the travel guide part 124 along the inflow region 124a. Here, if the inflow region 124a is formed as the inclined plane, motion energy of the target object 500 may be partially converted into potential energy, thereby appropriately reducing the travel velocity of the target object 500. However, unless the travel velocity of the target object 500 is significantly slow to a predetermined level or below, the inclination alone is incapable of completely blocking the travel of the target object 500. As a result, the target object 500 may naturally enter the collision region 124b by passing through the transition region 124c due to inertia. The collision region 124b is provided as a straight section, and the target object 500 may thus travel without a significant change in velocity, and end the travel by encountering and colliding with the travel blocking part 121.

In this way, when the object arrival part 120 includes the travel guide part 124, the object arrival part 120 may be implemented as a considerably structured product as illustrated in FIGS. 4 and 5. That is, the object arrival part 120 itself for forming the path space of the travel guide part 124 may be formed in a shape of the considerably structured product, and as illustrated in the drawings, the travel blocking part 121 or the device accommodating part 123 may be appropriately and easily disposed. Although the noise absorbing part 122 is not illustrated in FIGS. 4 and 5, it is entirely possible that the object arrival part 120 further includes the noise absorbing part 122, such as by placing a sponge on a front surface of the travel blocking part 121, if necessary.

Meanwhile, when the travel guide part 124 is configured in this way, the travel velocity of the target object 500 may be significantly reduced in the process of converting its motion energy into the potential energy while the target object 500 flows into and travels through the travel guide part 124, thereby inducing the target object 500 to almost come to a standstill after colliding with the travel blocking part 121. In this case, when the target object 500 returns from the travel guide part 124, a position of the travel guide part 124 in the length direction at which the target object 500 returns and then stops may be roughly determined by a height of the travel guide part 124, a path length, or the like. Basically, the height of the travel guide part 124 is directly related to the potential energy, and accordingly, the [position of the target object 500 at which the target object 500 returns and then stops] is also most deeply related to the height of the travel guide part 124. Meanwhile, if the path within the travel guide part 124 is formed to have high frictional resistance, the motion energy of the target object 500 may be considerably consumed as frictional energy, and in this case, [the position of the target object 500 at which the target object 500 returns and then stops] may also be related to the path length of the travel guide part 124.

### 4-2. Object arrival part according to a second embodiment

In the object arrival part according to the first embodiment, the transition region 124c is formed in the semicircular shape, thereby forming the travel directions of the target object 500 in the inflow region 124a and the collision region 124b in the opposite directions. In the object arrival part according to the second embodiment, the transition region 124c may be formed in a quadrant shape, and the collision region 124b may be formed as a straight path space. Accordingly, the travel direction of the target object 500 in the inflow region 124a and the travel direction of the target object 500 in the collision region 124b may be formed to be perpendicular to the bottom part 111.

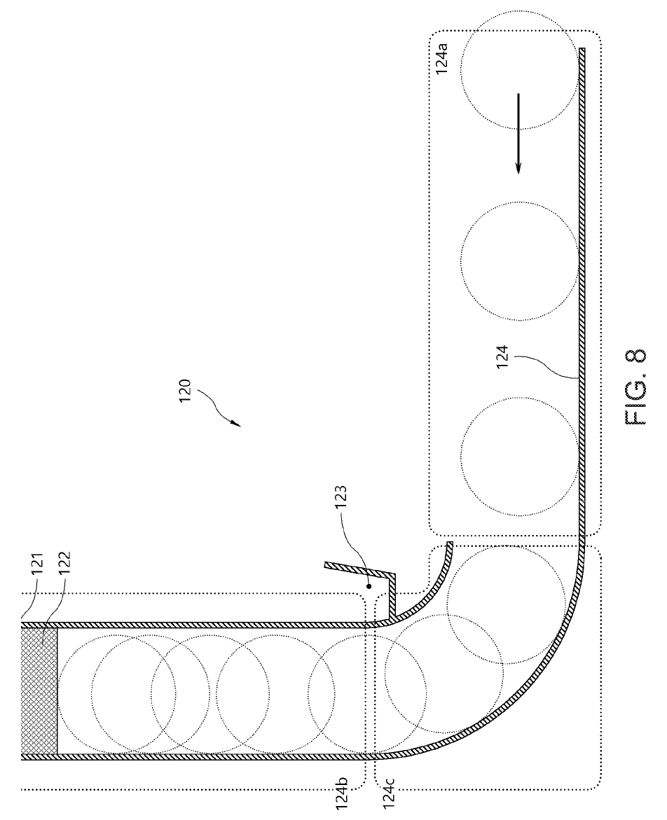

FIG. 8 illustrates a cross-sectional view of the object arrival part of the velocity measuring apparatus according to the second embodiment of the present disclosure. FIG. 8 illustrates that the inflow region 124a is formed as a horizontal plane that is the same plane as the bottom surface 111. However, the inflow region 124a may alternatively be formed as an inclined plane, as illustrated in FIG. 4 and the subsequent drawings. In the object arrival part according to the second embodiment, the collision region 124b may be formed to rise vertically, and the travel blocking part 121 may be formed as a blocking wall that blocks the end of the collision region 124b. In addition, the noise absorbing part 122 may be disposed on the front of the travel blocking part 121, thereby absorbing a significant amount of collision energy of the target object 500.

Meanwhile, when the velocity measuring apparatus 100 is used as a golf putting practice device, the travel velocity of the target object 500 may vary within a limited range that is known to some extent. Here, if a height of the travel blocking part 121, specifically a length of the collision region 124b, is appropriately designed, the target object 500 having a travel velocity within this range may collide with the noise absorbing part 122, thereby consuming all of its excess motion energy. In this case, after the collision, the target object 500 may fall while retaining only the potential energy equivalent to the height of the travel blocking part 121. Therefore, the position of the target object 500 at which the target object 500 returns and then stops may be entirely determined by the length of the collision region 124b. Considering this principle in reverse, the length of the collision region 124b may be appropriately determined and designed to make the [position of the target object 500 at which the target object 500 returns and then stops] correspond to the starting point 115. When the velocity measuring apparatus 100 is used as a golf putting practice device, the user convenience may be greatly improved by making the [position of the target object 500 at which the target object 500 returns and then stops] correspond to the starting point 115.

This configuration assumes that the travel velocity of the target object 500 falls within a predetermined limited range. Considering a golf putting practice situation, where putting practice is performed to achieve a predetermined velocity of the target object 500, this velocity may fall within the limited range described above. However, if necessary, the user may desire to practice achieving a greater velocity, and in such a case, the returning target object 500 may pass the starting point 115, which may reduce the user convenience.

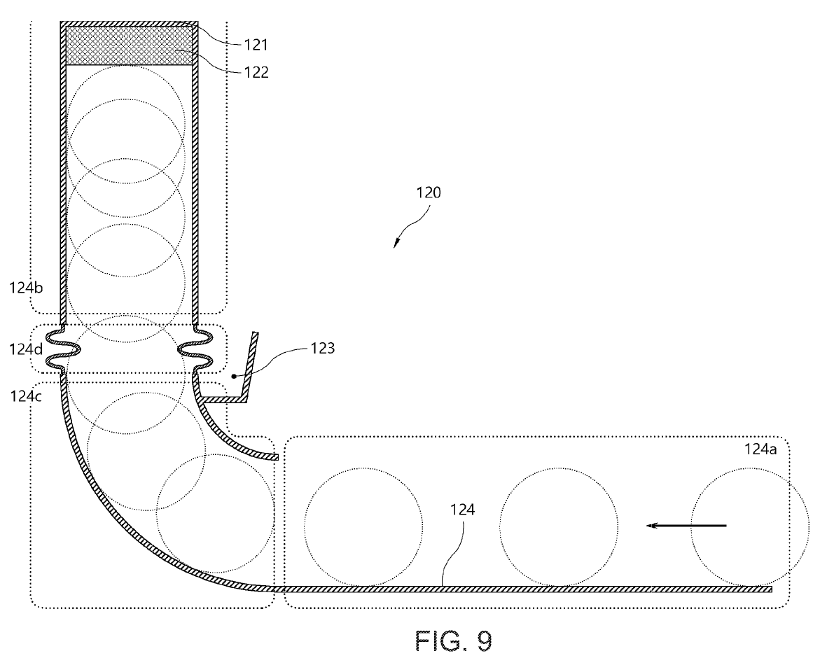

FIG. 9 illustrates an embodiment in which the object arrival part according to the second embodiment includes an additional component, that is, an additional component capable of solving the issue described above. In an embodiment in FIG. 9, a variable region 124d may be formed between the transition region 124c and the collision region 124b to vary an extension length of the path space. The height of the travel blocking part 121 may be more freely varied based on the variable region 124d. Therefore, for example, if the user desires to achieve a greater velocity during golf putting practice, the user may increase the variable region 124d to increase the height of the travel blocking part 121, and if the user desires to achieve an appropriate velocity, the user may reduce the variable region 124d to practice while lowering the height of the travel blocking part 121.

### 4-3. Object arrival part according to a third embodiment

As described above, depending on a way in which the travel guide part 124 is designed, the target object 500 may appropriately adjust the [position of the target object 500 at which the target object 500 returns and then stops]. However, this method may have a predetermined limitation, such as a case where the target object 500 travels at an excessively great velocity, thus preventing the noise absorbing part 122 or the like from sufficiently absorbing the energy of the target object 500, thus inevitably allowing the target object 500 to retain it initial velocity upon returning.

Considering this point, in order to reliably fix the [position of the target object 500 at which the target object 500 returns and then stops], it is necessary to provide a time point at which all the motion energy of the target object 500 is completely consumed within the collision region 124b, thereby making the target object 500 completely stop. The third extended embodiment is implemented by considering this point.

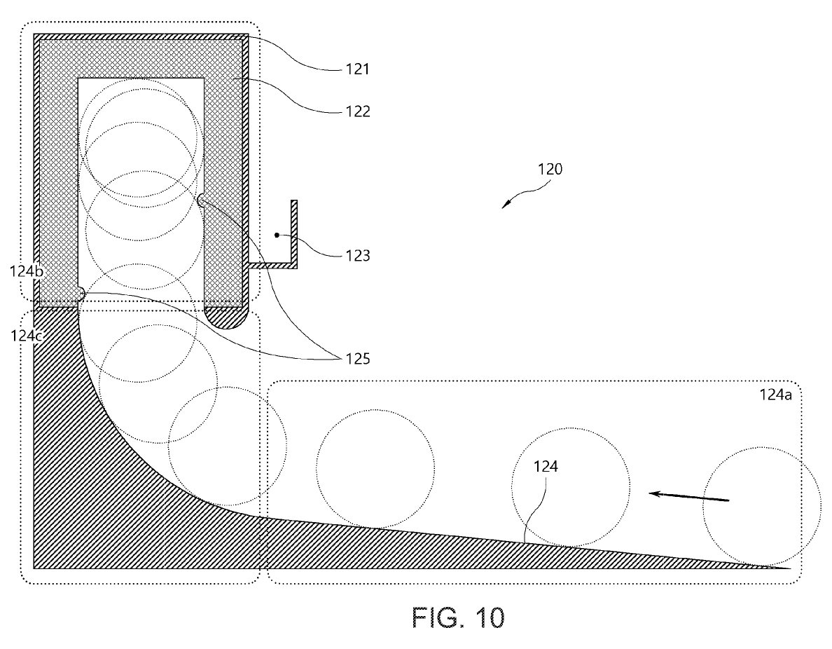

FIG. 10 illustrates a cross-sectional view of the object arrival part of the velocity measuring apparatus according to a third embodiment of the present disclosure. FIG. 10 illustrates that the path space itself has a shape similar to that of the object arrival part according to the second embodiment, in that the transition region 124c is formed in a fan shape close to the quadrant shape (because the inflow region 124a is formed as the inclined plane). In addition, similar to the object arrival part according to the second embodiment, the collision region 124b may be formed as a straight path space, and the travel direction of the target object 500 in the inflow region 124a and the travel direction of the target object 500 in the collision region 124b may be formed to be perpendicular to the bottom part 111. However, unlike the object arrival part according to the second embodiment, the object arrival part according to the third embodiment may include an object bouncing part 125.

The object bouncing part is described in more detail in the object arrival part according to the fourth embodiment below.

### 4-4. Object arrival part according to a fourth embodiment

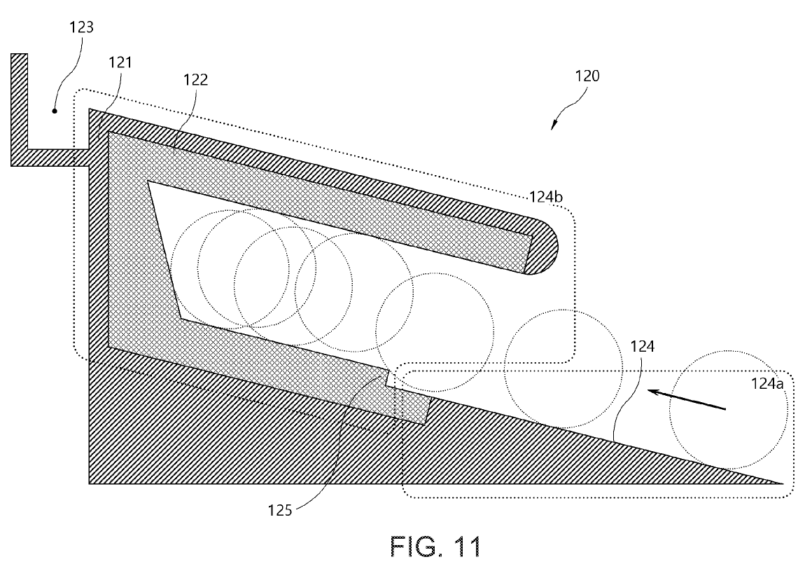

FIG. 11 illustrates a cross-sectional view of the object arrival part of the velocity measuring apparatus according to the fourth embodiment of the present disclosure. Unlike the previous path spaces, the path space in FIG. 11 has the travel direction of the target object 500 in the inflow region 124a and the travel direction of the target object 500 in the collision region 124b in the same direction. That is, in this case, the object arrival part does not include the transition region 124c. Instead, the object arrival part according to the fourth embodiment may also include the object bouncing part 125 (although its implementation form is slightly different from that of the object arrival part according to the third embodiment).

The object bouncing part 125 may function to allow the target object 500 to be caught by the object bouncing part 125 and bounce off while traveling at a starting position of the collision region 124b. Specifically, the object bouncing part 125 may be formed as a protrusion, and the plurality of object bouncing parts 125 may be provided, as in the object arrival parts according to the third embodiment of FIG. 10, or may be formed as a catching step, as in the object arrival part according to the fourth embodiment of FIG. 11.

A technical concept of the object bouncing part 125 is described as follows. When the target object 500 encounters the object bouncing part 125 while traveling through the path space formed by the travel guide part 124, the target object 500 may naturally be caught by the object bouncing part 125 and slightly bounce off. However, the path space through which the target object 500 passes may have a size almost identical to that of the target object 500, and the target object 500 may thus collide with an opposite wall even if the target object 500 bounces slightly. This rebound may cause the target object 500 to bounce back, and such collisions may inevitably occur multiple times. That is, after passing the object bouncing part 125, the target object 500 may collide multiple times with the ceiling, floor, and travel blocking part 121 of the path space within the collision region 124b. Each time the collision occurs, the motion energy of the target object 500 may be consumed due to noise or the like. That is, the motion energy of the target object 500 may be actively consumed by intentionally inducing such collisions.

When all the motion energy of the target object 500 is consumed in this manner, at least one time point may be generated at which a velocity component of the target object 500 in the travel direction becomes zero. That is, the target object 500 may necessarily implement a state in which the initial velocity of the target object 500 becomes zero, thereby fixedly determining the [position of the target object 500 at which the target object 500 returns and then stops] based only on the potential energy of the target object 500.

### 4-5. Object arrival part according to a fifth embodiment

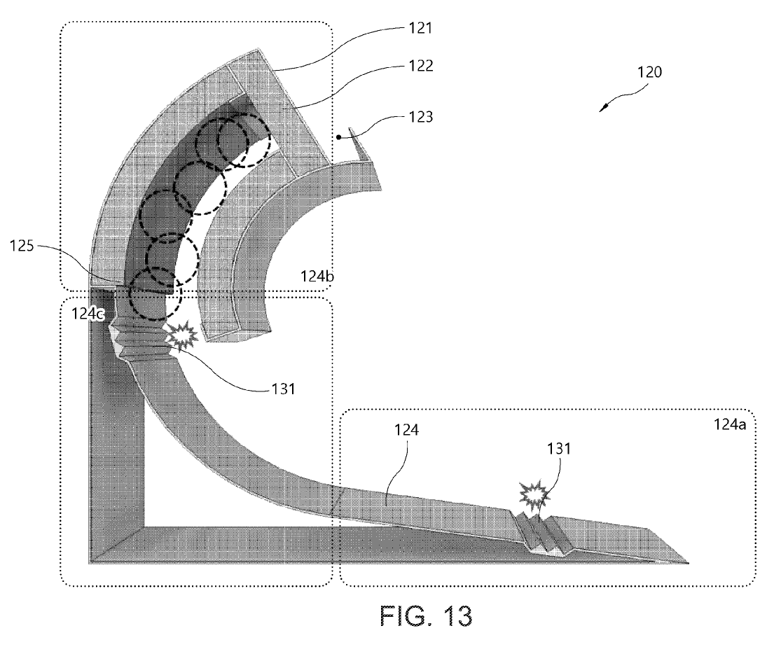

FIGS. 12 and 13 illustrate cross-sectional views of the object arrival part of the velocity measuring apparatus according to the fifth embodiment of the present disclosure, in which FIG. 12 illustrates a cross-sectional view thereof and FIG. 13 illustrates a perspective view thereof, respectively.

Similar to the object arrival parts according to the second and third embodiments described above, in the object arrival part according to the fifth embodiment, the transition region 124c may be formed in a fan shape close to the quadrant shape (because the inflow region 124a is formed as the inclined plane). However, unlike the object arrival parts according to the second and third embodiments, the collision region 124b may be formed as a curved path space having the same curvature as the transition region 124c. Accordingly, in the object arrival part according to the fifth embodiment, the travel direction of the target object 500 in the inflow region 124a may be formed in a tangential direction relative to a trajectory in the transition region 124c or the collision region 124b.

In the object arrival part according to the fifth embodiment, as described above, the transition region 124c and the collision region 124b may be formed as trajectories having the same curvature. Accordingly, the travel of the target object 500 may become more natural, and an overall device volume may be reduced compared to when the collision region 124b is formed in a vertical orientation.

In addition, in the object arrival part according to the fifth embodiment, the object bouncing part 125 may be formed similarly to the object arrival part according to the third embodiment. Accordingly, the target object 500 may arrive and then naturally return to the desired position based on its shape alone without any separate device. FIG. 12 illustrates that the object bouncing part 125 is formed as a protrusion, and FIG. 13 illustrates that the object bouncing part 125 is formed as the catching step. Therefore, the embodiments in FIGS. 12 and 13 are slightly different from each other. However, the object bouncing part 125 may be formed into any shape as long as the object bouncing part 125 has a structure that allows the target object to bounce.

In addition, in all the object arrival parts according to the third, fourth, and fifth embodiments, the interior of the collision region 124b may be completely surrounded by the noise absorbing part 122, and the object bouncing part 125 may be formed as a surface-protrusion structure of the noise absorbing part 122. In general, a noise absorbing material is porous and flexible, and not only smoothly absorbs noise when the target object 500 collides, but also reduces rebound impact returning to the target object 500, thereby preventing damage to the target object 500.

Meanwhile, in FIG. 4, which illustrates the object arrival part according to the first embodiment, the noise generating part 130 is formed in the shape of the bottom line 131, and the bottom line 131 is formed on the bottom part 111 of the object travel part 110. However, the position of the bottom line 131 may be determined only by the position of the arrival point, and may actually be formed anywhere. FIGS. 12 and 13 illustrate an example in which the noise generating part 130 formed in the shape of the bottom line 131 is provided on the object arrival part 120.

In particular, FIGS. 12 and 13 illustrate an example in which the bottom lines 131 are formed at two different positions. As described above, when the target object 500 passes over the bottom line 131, specific noise such as a "ta-ta-tap" sound may occur due to the unevenness. Here, the bottom line 131 disposed near the collision region 124b of the travel guide part 124, that is, the region including the travel blocking part 121, may be considered to function to notify the [arrival]. Meanwhile, the bottom line 131 disposed in the inflow region 124a of the travel guide part 124 may function to notify that the [arrival] is near, or to notify the [departure] when the inflow region 124a is sufficiently long. As described above, when the velocity measuring apparatus 100 is used as a putting practice device, noise occurring when striking a golf ball (i.e., the target object) using a golf club may be set as the departure signal, and its unique frequency or the like may be pre-stored. This stored information may be used as a reference for determining whether measured noise corresponds to the departure signal. However, the departure signal does not necessarily have to be striking noise. As illustrated in FIGS. 12 and 13, the bottom lines 131 may be formed near the starting point, where one of the two bottom lines may function to notify the [departure] and the other may function to notify the [arrival]. In addition, FIGS. 12 and 13 illustrate that two bottom lines are all formed on the object arrival part 120 to show an example in which the departure and the arrival are indicated by two bottom lines in a single drawing. However, various modifications are possible, for example, one of the two bottom lines may be formed on the object arrival part 120 to indicate the arrival, and the other line may be formed on the object travel part 110 to indicate the departure.

As set forth above, according to the present disclosure, the velocity may be measured at the considerably high accuracy by using even the simpler configuration than before, by generating two or more noise or vibration events that inevitably accompany the passage of the target object and calculating the section velocity based thereon. More particularly, according to the present disclosure, the velocity measurement is possible by using only the portable device (e.g., a personal smartphone) capable of detecting noise and vibration, without installing any separate signal generator for the velocity measurement. Accordingly, the installation of the velocity measuring apparatus does not require additional sensors or power supplies for the measurement, or the like, thus making the configuration simple and requiring no additional costs, which may provide the economic benefits to the user.

In addition, according to the present disclosure, the operation such as the velocity measurement algorithm performance or the data storage may be performed on the portable device, which enables the various uses such as using the measured data as the base data for operating other programs, thereby providing the highly expandability.

The present disclosure is not limited to the above-described embodiments, may be variously applied, and may be variously modified by those skilled in the art to which the present disclosure pertains without departing from the gist of the present disclosure claimed in the appended claims.

What is claimed is:

1. A velocity measuring apparatus comprising:
an object travel part extending in one direction and forming a travel path of a target object;
an object arrival part disposed at one end of the object travel part and causing the target object traveling from a starting point at the other end of the object travel part to complete its travel by colliding with the object travel part; and
a computation unit having a position predetermined on the object travel part or the object arrival part,
receiving in advance, as a travel distance, a distance between measurement points formed to induce noise or vibration from the target object,
recognizing noise or vibration as a measurement signal by including a built-in acoustic sensor or gyro sensor, and
calculating a velocity of the target object based on a travel distance value and a time difference value between the measurement signals,
wherein the computation unit and an assembly of the object travel part and the object arrival part are formed as completely independent structures, and
the computation unit is detachably mounted on the object arrival part in a manner that the computation unit is placed and mounted on the object arrival part or the computation unit placed on the object arrival part is removed by being picked up therefrom.

2. The apparatus of claim 1, wherein the computation unit recognizes, as the measurement signal, noise detected when the target object passes the measurement point or vibration detected when the target object arrives at and collides with the object arrival part.

3. The apparatus of claim 2, wherein the object travel part includes
a bottom part extending in a length direction and formed as a plane parallel to the ground, and
side wall parts protruding in a height direction from both ends of the bottom part in a width direction,
when the extension direction of the object travel part is referred to as the length direction,
a direction intersecting the object travel part is referred to as the width direction,
a direction perpendicular to the length direction or the width direction is referred to as the height direction,
a side toward the starting point is referred to as the front, and
a side toward the object arrival part is referred to as the rear.

4. The apparatus of claim 3, wherein the object arrival part includes a travel blocking part fixed thereto and blocking the travel of the target object by colliding with the target object while traveling.

5. The apparatus of claim 4, wherein the object arrival part includes a noise absorbing part partially absorbing impact and noise occurring when the target object collides with the travel blocking part.

6. The apparatus of claim 4, wherein the object arrival part includes a device accommodating part accommodating the computation unit.

7. The apparatus of claim 4, further comprising a noise generating part generating noise when the target object passes thereover,
wherein the measurement signal includes at least two selected from
noise occurring when the target object is struck upon departure,
noise occurring when the target object passes the measurement point,
vibration occurring when the target object arrives at the object arrival part.

8. The apparatus of claim 7, wherein the noise generating part includes a plurality of bottom lines formed in shapes of mountains or valleys on a travel plane on which the target object travels, and
spaced apart from each other in the length direction.

9. The apparatus of claim 7, wherein the noise generating part includes a separation line extending in the width direction, and separated from the travel plane on which the target object travels.

10. The apparatus of claim 9, wherein the noise generating part includes the separation line disposed near the bottom part and causing noise by vibrating itself when the target object steps on and passes over the separation line,
the separation line disposed at a height close to a height of the target object and causing noise by allowing the target object to be caught by the separation line and bounce off.

11. The apparatus of claim 7, wherein if a single noise generating part is disposed on the object travel part, the noise generating part is disposed near the front of the object arrival part in the length direction, and
if the plurality of noise generating parts are disposed on the object travel part, one selected noise generating part is disposed near the front of the object arrival part in the length direction, and the other noise generating parts are distributed at predetermined positions in the length direction.

12. The apparatus of claim 7, wherein the object arrival part includes a travel guide part formed in a predetermined path space shape and guiding the travel path of the target object.

13. The apparatus of claim 12, wherein the travel guide part includes
an inflow region formed as a straight path space including a bottom surface having one end in close contact with the bottom part and having the same plane as the bottom part or an inclined plane inclined relative to the bottom part to allow the target object to flow thereinto, and
a collision region formed as a straight or curved path space to guide the target object to travel toward and collide with the travel blocking part.

14. The apparatus of claim 13, wherein the travel guide part includes at least one object bouncing part formed as a protrusion or a catching step to allow the target object to be caught and bounce off as the target object travels at a starting position of the collision region.

15. The apparatus of claim 14, wherein the travel guide part causes the target object, after passing the object bouncing part, to consume motion energy by colliding multiple times with the ceiling, floor, and travel blocking part of the path space within the collision region, thereby generating at least one time point at which a velocity component of the target object in a travel direction becomes zero.
